(19) United States
(12) Patent Application Publication
(10) Pub. No.: US 2006/0031348 A1
(43) Pub. Date: Feb. 9, 2006

(54) Method and system for internet delivery of customized information packages

(75) Inventor: Susan Jean Fox, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Casting Workbook Services Inc., Vancouver (CA)

(21) Appl. No.: 11/101,539

(22) Filed: Apr. 8, 2005

Related U.S. Application Data
(60) Provisional application No. 60/560,595, filed on Apr. 9, 2004.

(51) Int. Cl. G06F 15/16; H04L 9/32

(52) U.S. Cl. 709/206; 726/4

(57) ABSTRACT

Previously talent was pitched by agents to studios using physical files and couriers. What is disclosed is a method of creating and delivering by email for viewing by one or more selected recipients, each recipient having a computer with a web browser, a customized compilation of one or more digital files, such as a portfolio, where a user who has accessed a web site using a secure password selects the content of the pitch which is sent by email to the recipients and the email contains secure links to the digital content.

### REFERENCE TO RELATED APPLICATION

This application claims priority from U.S. provisional application No. 60/560,595 filed Apr. 9, 2004, which is pending.

### TECHNICAL FIELD

The invention relates to methods and systems for delivering customized packages of information to entertainment industry professionals and more particularly to methods and systems for delivering customized packages of information pitching artists or projects by using the Internet.

### BACKGROUND

Traditionally in the entertainment industry, including the theatrical, film and television industries, the act of promoting a project such as a script, pilot or screenplay, or an actor to a studio or casting director is referred to as “pitching”. When someone wanted to “pitch” information about a project or artist, they would gather the physical content and put it in a package or envelope and then have it physically delivered to the intended recipients, who traditionally have been Casting Agents, Directors and/or Producers. The contents of the package (referred to herein as the “Pitch”) vary, but generally for an artist include photographs (also known as headshots) of the artist, a VHS tape or DVD for any audition or an edited clip from an actual produced feature or television episode and documents including resume and press. For a project, it could include a Press Kit, with a VHS Tape or DVD of the trailer.

Some of the inherent costs for the Sender with the traditional method of “pitching” are the time to gather this information from various sources, the cost of duplicating the content multiple times and the cost of physical delivery, either by a local messenger or FedEx™. The Recipient also incurs costs with these packages they receive, both in time and resources. For example, a Casting Director would traditionally hire an assistant to open and sort through the materials and there is a cost of storing the materials. In many cases the packages may never be opened by a recipient due to the large number of such packages they receive, or the contents may be lost or separated.

Currently, the use of computers is common-place in the entertainment industry and many of the materials that are sent out in such packages are now being stored electronically in a digital format. However the sender still downloads and prints the content for sending and often keeps two copies of the same content, one digital, one physical. So therefore there is a need to be able to send this information in a secure fashion to a recipient. The recipients should also be able to use their existing email client to sort and organize the packages as they are received, thereby saving the cost of an assistant to organize them. Also, it would be advantageous for the Sender to see when the package was opened and by whom. Currently the sender has no way of knowing if the recipient has looked at the content There is no way of tracking the package except through the courier. Also it would be beneficial to take advantage of the utility of email for sending the same material many times to numerous Recipients.

In recent years a set of specifications has been standardized for a model of distributed computing architecture called XML Web Services. A Web Service is a software system designed to support interoperable machine-to-machine interaction over a network. It has an interface described in a machine-processable format (specifically WSDL). Other systems interact with the Web service in a manner prescribed by its description using SOAP-messages, typically conveyed using HTTP with an XML serialization in conjunction with other Web-related standards. XML Web Services standards provide a high level of interoperability across platforms, programming languages and applications. Web Services are a loosely-coupled, language-neutral, platform-independent way of linking applications across the Internet.

### SUMMARY OF INVENTION

The invention therefore provides method of creating and delivering by email for viewing by one or more selected recipients, each recipient having a computer with a web browser, a customized compilation of one or more digital files, wherein the digital files are associated with an identifying code, comprising: i) storing the digital files in the memory of a secure database in association with the identifying code; ii) providing a web site accessible over the Internet; iii) displaying to a user who has accessed the web site using a secure password a plurality of selections for selecting the content of the email, including selecting the one or more digital files in association with the identifying code and one or more selected recipients; iv) forming and sending the email to the recipients wherein the email contains one or more secure links to the digital files, whereby the recipient can access the digital files using the web browser. Preferably the step of forming and sending said email to said recipients is carried out by a Web Service to allow different digital objects to be selected. The compilation of digital files may be a portfolio for a talented individual and said one or more selected recipients are the target of a pitch by an agent for said talented individual.

### BRIEF DESCRIPTION OF DRAWINGS

In drawings which disclose a preferred embodiment of the invention,

FIG. 1 is a block diagram illustrating a computer network for carrying out the invention;

FIG. 2 is a Flow Chart illustrating the method according to the invention;

FIG. 3-7 are copies of web pages displayed during the operation of the invention; and

FIG. 8 is a print-out illustrating an email sent according to the method of the invention.

### DESCRIPTION

Throughout the following description, specific details are set fort in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

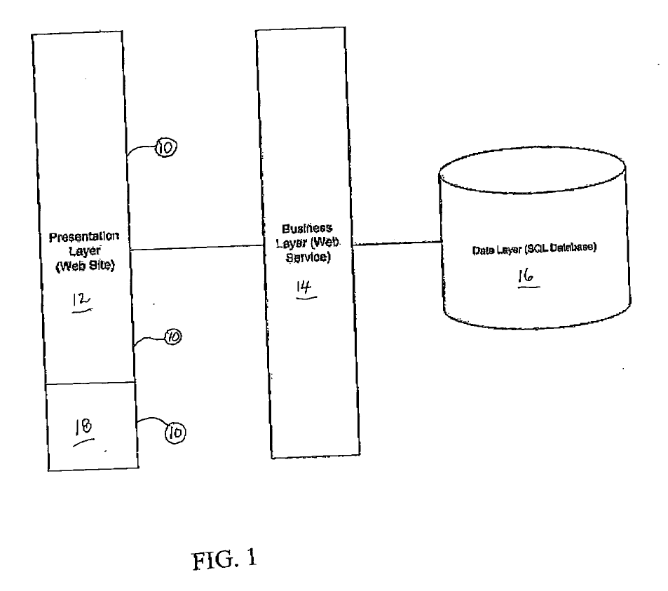

With reference to FIG. 1, a number of potential users 10 have access to the Internet using Internet browser software. The present invention uses a three-layer system, the Presentation Layer, Business Layer and Database Layer, wherein the Business Layer is maintained in a secure Web Service 14. Users 10 have access to the Portal Web Site 12 by entering the URL into the address bar of their web browser. Portal Web Site 12 functions as the Presentation Layer, and provides the graphical interface for users to access the forms necessary for creating, sending and viewing a Pitch, as well as for talent or agents to add or edit a portfolio. A Web Service 14 is used to communicate to a secure Database 16 and to perform the Business Layer functions. For example, a web site at www.castingworkbook.com, would act as a portal web server which will serve as the Presentation Layer of the invention. The User 10 will not be aware of any differences in functionality between the Web Service 14 and Presentation 12 layers due to seamless integration.

The sending and retrieving of information in a Pitch is done by the Web Service 14 which communicates with database 16 to store, assemble, send and retrieve information for viewing on a secure sub-site 18 not accessible to the public from the main portal site 12 to prevent hackers from accessing personal information. The web service 14 contains the functionality to create, view and manage the Pitches. Database 16 may be a commercially available relational database. It stores the potential content to be selected for the Pitches as well as sender and recipient information and information for reporting on the Pitches.

The objects and terminology that will be used are similar to the traditional method of sending a physical “pitch” or promotional package; a package is assembled using content or elements either pre-organized in a Portfolio or separately compiled. The definition of a Portfolio is simply an organized set of elements. An element can be anything that can be stored and viewed or downloaded through a web browser, for example database content, photographs, images, video clips, audio clips and text documents. Each Pitch is one package, and a package can have many portfolios and/or elements.

As part of the system, talented individuals such as actors, models, and others such as photographers, dancers, musicians, singers, writers etc. (“talent”) can sign up for the system by visiting the portal web site 12 and are each provided a unique identification code and password. If represented by an agent, the talent will identify the agents' roster or rosters to which the talent belongs and that individual will be associated also with his or her agent's or agents' unique identifiers. The talent, or the talent's agent, selects from his/her computer digital files to be uploaded and stored on database 16 in association with that individual's unique identifier.

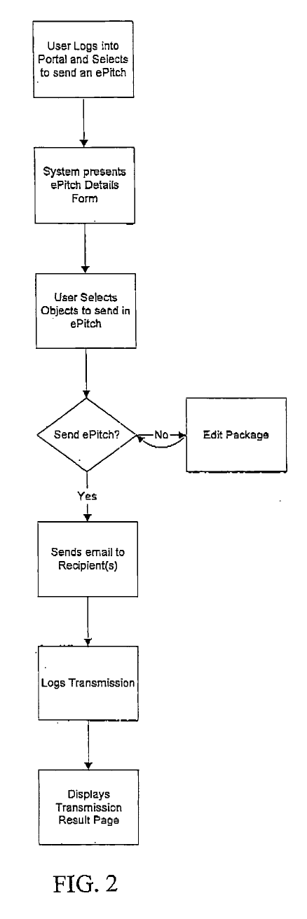

An Agent who has subscribed to the system can create and send the Pitch as follows. FIG. 2 outlines the basic flow for sending one Pitch.

Create Pitch

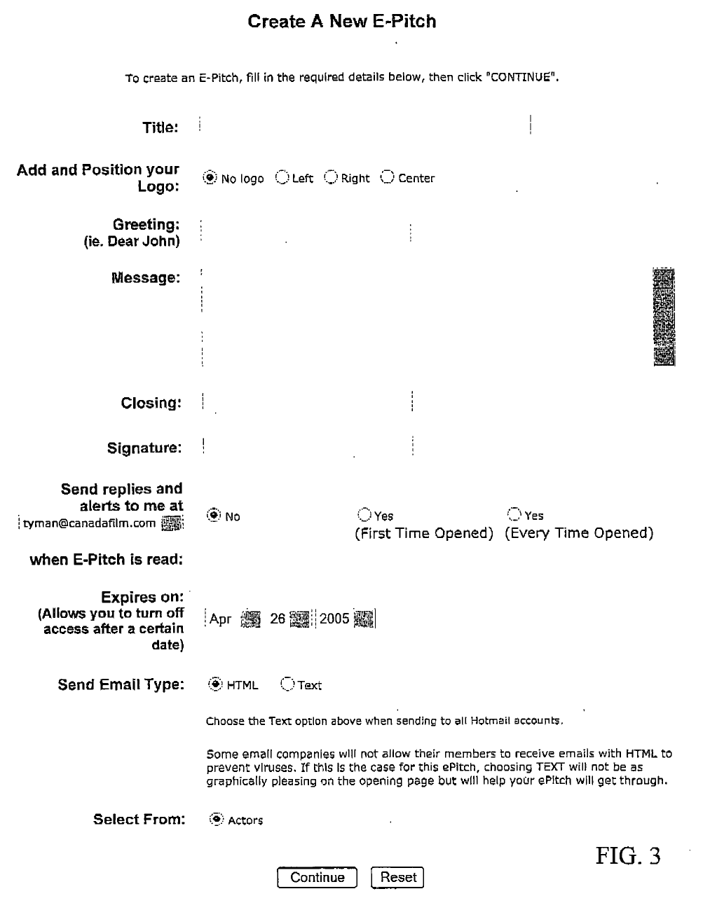

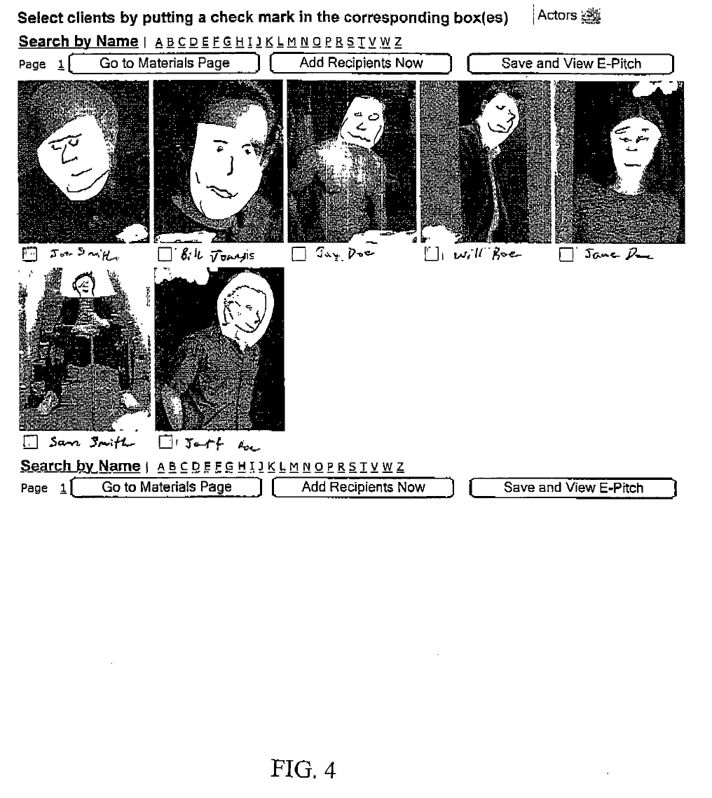

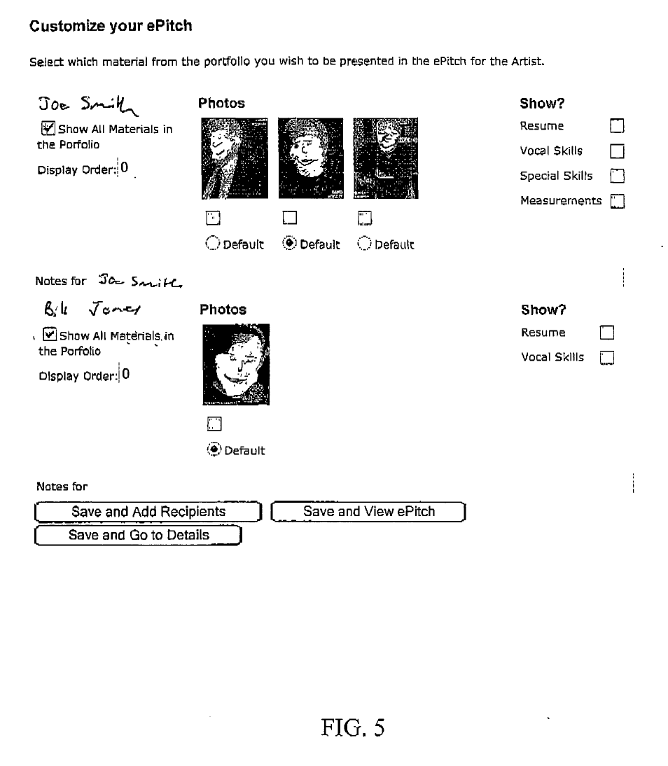

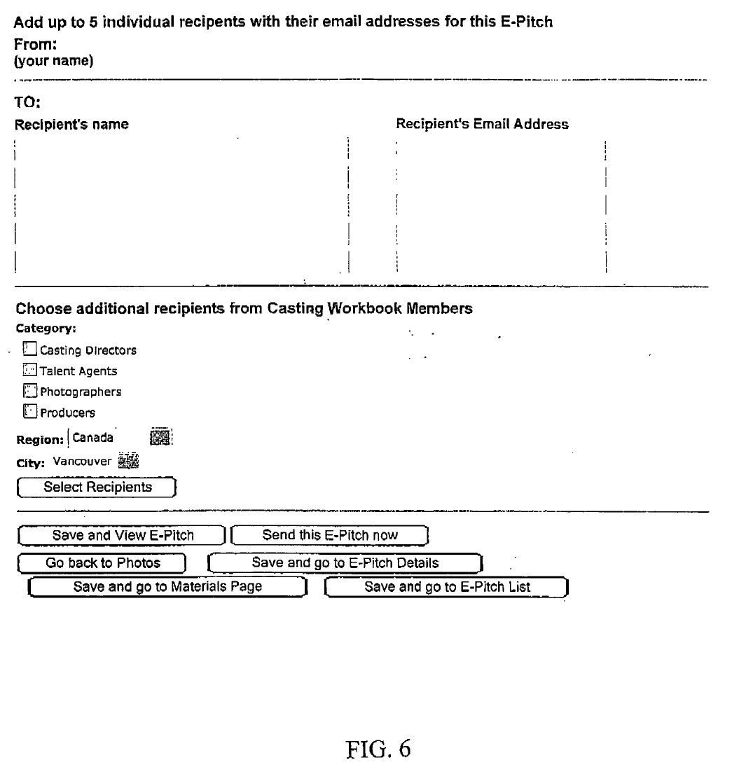

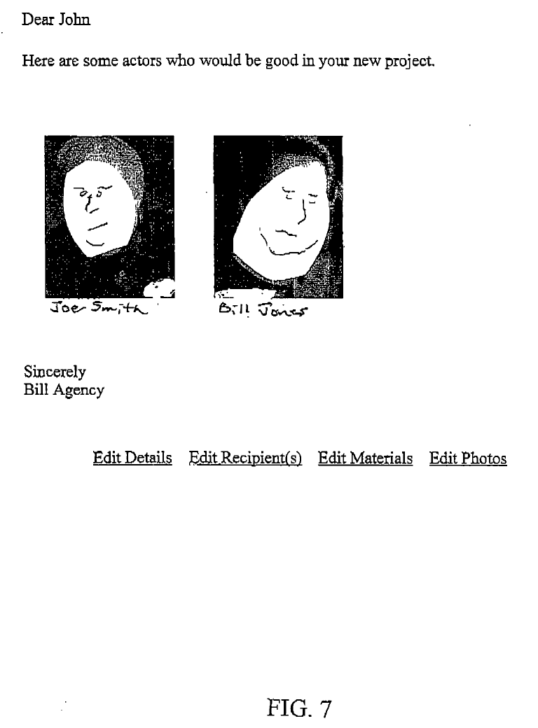

After accessing the portal web site 12 and signing onto the system with a secure password, the User such as an Agent or oilier party wishing to create a Pitch selects a button to be directed to the page to create a Pitch, as shown in FIG. 3. Here the User provides the System with the basic information such as the content of the cover email, title of the Pitch for subject line of the email and later reference, security options, tracking options, expiration options, recipient information and package information. For each Pitch the following sequence of screens will be presented.
A) A form shown as FIG. 3 asking for basic information about the Pitch, such as Title. The Sender may optionally choose to provide a greeting, salutation and custom message and signature to be included in the email and how and when to be alerted when the Pitch is viewed. They also will choose security options, namely the ability to assign an expiration date to the Pitch. Then, if a recipient tries to view a Pitch after the expired date a message will be sent stating that the Pitch is unavailable. Another security option (not shown) will prevent a Pitch from being forwarded or opened on a computer other than the computer which first opened the received Pitch email. Another security option (not shown) is to limit the number of times that the Pitch can be viewed by the recipient. For example, if the recipient is restricted to viewing the Pitch twice, on the third attempted viewing the recipient will receive a message that the Pitch is unavailable. A tracking option allows the sender to be notified by email when the recipient first opens the email, or every time, or not at all, and the email address to which the notification is sent. The system may store the tracking information whether or not the sender requests notification. The sender can also select whether the Pitch should be text or HTML.
B) Upon submitting the form shown in FIG. 3, the Sender then selects the content of the Pitch. The Sender will then be directed to the page shown in FIG. 4 to assemble the package, where he or she can choose from a pre-selected set of Talent or Projects and view the pre-created Portfolios, or create a package by selecting various elements from the database as it relates to the Talent or Project to which they have access. The system's Presentation Layer 12 will call the Web Service Layer 14 which will handle the database transactions. The User searches the database for an actor or project or company which has stored a portfolio on the database. In some cases an actor, project or company may have stored multiple portfolios. Where the user is an agent, the page will display all the actors in that agent's roster, for example, with thumbnail photos. By selecting individual actors, and proceeding to the Materials Page shown in FIG. 5, the User selects which materials which are stored in database 16 in connection with that actor to include in the Pitch, such as resumé, audio or video files, photographs etc. The user can select the entire portfolio of the actor etc. to be included in the Pitch or particular files. The sender can also add a note specific to the content which will be displayed with the graphical representation. For example, a note about the actor may be displayed under a large thumbnail photo. According to an alternate method, the User can search the database directly for content files to be included in the Pitch, by identification code, or keyword or by selecting from a list, rather than searching by the name of the individual actor or project.
C) The Sender by selecting the page shown in FIG. 6 may then select the recipient or recipient groups from his or her personal address book, or database or a directory of other users, or add recipient names and email addresses. The user can then elect to send the Pitch email, or select to pre-view the email.
D) If “View” is selected, then the System presents a preview of the Pitch email package as shown in FIG. 7. The Sender can then edit the information or return to the Recipients page to send it, or save the Pitch for sending later. Once saved, the Pitch is added to a list from which it can be selected and sent.
   Send Pitch

After the Sender clicks on “send”, the System sends a request to the Web Service 14 which then assembles the email based on the User's previous input, e.g. having the Greeting, Salutation and/or Custom Message from the Sender, as well as icons or thumbnail photos which provide secure links to the selected content in the Pitch and then transmits the email to each Recipient. A unique identification key is generated for each email and is included in the secure links to the content The unique identification key is required for the Recipient to view the linked content. The System uses the identification key to verify the Recipients identity before allowing access to the content. It is also used to track the Recipients actions. The System will also log each email transmission for success or failure and provide to the Sender a report from the transmission log.

View Pitch

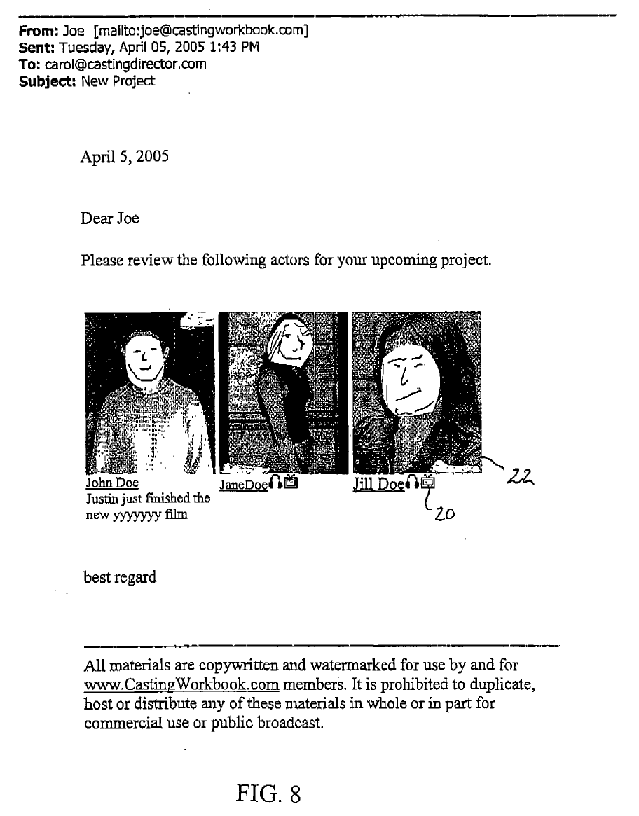

FIG. 8 illustrates the Pitch email received and opened by the Recipient. It shows the Sender's email address as the “from” address so the Recipient can reply directly to the Sender. In the email, the Recipient will either have an icon 20 or thumbnail photo 22 if they allow HTML in their email messages or a link for those who limit their emails to text only. The Recipient will click on the icon or thumbnail to be taken to a secure Sub-Site 18 to view a text, audio or video file or photograph. The Web Service 14 verifies the recipient's identity using the identification key embedded in the email links. The system records the entry of the recipient to the content and records the recipient's clicks as each content is reviewed. For example, if the Pitch contains an actor's portfolio that has videos, as the recipient views each video the invention records the date and time the recipient accessed the video. The Recipient view of the content will only be of the content of the package. They will not have full access to the main application, nor content other than that in the Pitch, nor will they be able to see the URL which the content is delivered from. Each time the recipient seeks to access content from the Pitch, that fact is recorded and the security and notification options are checked. If the Pitch is no longer accessible an email message is sent to the recipient and access is denied. The sender will also be notified by email as requested.

Manage Pitch Archive

The invention will keep a history of all Pitches created and saved, both sent and unsent. The sender can view, edit, resend, and delete Pitches. Any Pitch not sent will have the status of Pending. Even if a Pitch is sent, the sender still has the ability to edit the content and the changes will be reflected immediately. If any of the content is updated, for example, a video is replaced with a different one then the change will be immediate. If the content is removed then it will immediately no longer be accessible. The sender can copy a historical Pitch to create a new Pitch. The newly created Pitch is completely identical, except the Title must be unique. The invention will put the words “Copy of” in front of the new title. The new Pitch would be edited and then sent in the same process as creating an Pitch. The new Pitch is automatically saved the moment is created.

The sender can view the Transmission and View reports. The Transmission report is the success or failure of the emails as they were sent from the invention's mail server. The View report can be viewed in a text or graphical format. The text format details the sender and how many times they view the Pitch and what content they viewed. The graphical format represents the overall total of how many times all the recipients have viewed the Pitch. The sender clicks on the bar graph and the invention then displays a more detailed graphic of the recipients and how many times they viewed the Pitch. The sender clicks the bar on the graph for each recipient to see more details of how many tines the recipient has viewed all the content in the Pitch.

An advantage of the above-described method of pitching using the internet is that information about the Talent or Project is kept current, with the option to expire the information if Recipient has not accessed the information by a selected date.

As described above, this invention operates as a Web Service using a system architecture which is a Service Oriented Application that allows other applications to use the functionality of sending Pitches. This invention will thus be able to integrate with any application that needs the ability to send materials over the internet through email to an unspecified number of recipients. A Service Oriented Application uses Web Services to provide the data layer, with different graphic interfaces, as the presentation layer. This allows the invention to be portable to different applications that use the same content or different content and different databases. Thus while the description above describes Pitching content associated with an actor's portfolio, the invention also has application to customized compilation and delivery of other types of digital files or objects.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of creating and delivering by email for viewing by one or more selected recipients, each said recipient having a computer with a web browser, a customized compilation of one or more digital files, wherein said one or more digital files are associated with an identifying code, comprising:
i) storing said one or more digital files in the memory of a secure database in association with said identifying code;
ii) providing a web site accessible over the Internet;
iii) displaying to a user who has accessed said web site using a secure password a plurality of selections for selecting the content of said email, including selecting said one or more digital files in association with said identifying code and one or more selected recipients;
iv) forming and sending said email to said recipients wherein said email contains one or more secure links to said one or more digital files, whereby said recipient can access said one or more digital files using said web browser.

2. The method of claim 1 wherein said step of forming and sending said email to said recipients is carried out by a Web Service.

3. The method of claim 1 wherein said compilation of digital files is a portfolio for a talented individual and said one or more selected recipients are the target of a pitch by an agent for said talented individual.

4. The method of claim 3 wherein said one or more digital files are associated with a second identifying code representing said agent.

5. The method of claim I wherein a time limit is selected by said user for accessing said one or more digital files by said one or more selected recipients.

6. The method of claim 1 wherein said user sets a specific number of times the content can be seen by the recipient.

7. The method of claim 1 wherein said recipient is prevented from viewing said digital files from a computer other than said recipient's computer.

8. The method of claim 1 wherein said recipient is prevented from forwarding said email.

9. The method of claim 1 wherein said user selects when to be notified that said recipient has viewed said digital files.

10. The method of claim 1 wherein said user is able to save said email and select to send a previously saved email.

11. A computer program product for creating and delivering by email for viewing by one or more selected recipients, each said recipient having a computer with a web browser, a customized compilation of one or more digital files, wherein said one or more digital files are associated with an identifying code, comprising;
a computer usable medium having computer readable program code means embodied in said medium for:
i) storing said one or more digital files in the memory of a secure database in association with said identifying code;
ii) providing a web site accessible over the Internet;
iii) displaying to a user who has accessed said web site using a secure password a plurality of selections for selecting the content of said email, including selecting said one or more digital files in association with said identifying code and one or more selected recipients;
iv) forming and sending said email to said recipients wherein said email contains one or more secure links to said one or more digital files, whereby said recipient can access said one or more digital files using said web browser.

12. The computer program product of claim 11 wherein said step of forming and sending said email to said recipients is carried out by a Web Service.

13. The computer program product of claim 11 wherein said compilation of digital files is a portfolio for a talented individual and said one or more selected recipients are the target of a pitch by an agent for said talented individual.

14. The computer program product of claim 13 wherein said one or more digital files are associated with a second identifying code representing said agent.

15. The computer program product of claim 11 wherein a time limit is selected by said user for accessing said one or more digital files by said one or more selected recipients.

16. The computer program product of claim 11 wherein said user sets a specific number of times the content can be seen by the recipient.

17. The computer program product of claim 11 wherein said recipient is prevented from viewing said digital files from a computer other than said recipient's computer.

18. The computer program product of claim 11 wherein said recipient is prevented from forwarding said email.

19. The computer program product of claim 11 wherein said user selects when to be notified that said recipient has viewed said digital files.

20. The computer program product of claim 11 wherein said user is able to save said email and select to send a previously saved email.
